(19) United States
(12) Patent Application Publication
(10) Pub. No.: US 2005/0164825 A1
(43) Pub. Date: Jul. 28, 2005

(54) Cone ring transmission

(76) Inventor: Matthias Reisch, Ravensburg (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 11/017,462

(22) Filed: Dec. 20, 2004

(30) Foreign Application Priority Data
Jan. 24, 2004 (DE) 10 2004 003 716.7

(51) Int. Cl. F16H 15/42

(52) U.S. Cl. 476/52

(57) ABSTRACT

A transmission is proposed having two mutually opposed, rotationally symmetric rotating bodies arranged on two shafts, in particular a conical ring transmission with a primary cone and a secondary cone and with a ring which is engaged with both cones and surrounds one of the cones, in which shafts (5, 6) for the rotationally symmetric bodies or for the primary cone (2) and the secondary cone (3) enclose between them an angle not equal to zero.

The present invention concerns a conical ring transmission with two rotating cones arranged opposite one another on two shafts, namely a primary cone and a secondary cone and with a ring that surrounds one of the cones and engages with both cones according to the preamble of claim 1.

From EP 878 641 a continuously variable conical ring transmission is known, which comprises two conical friction wheels arranged on parallel shafts a radial distance apart and are arranged in opposition to one another and have the same cone angle. Between the conical friction wheels, a friction ring is arranged that fills the space between them, which surrounds one of the two conical friction wheels and is held in a cage.

The cage consists of a frame formed of two crosspieces and two parallel axles held therein. On the axles, an adjacent bridge is arranged with guide rolls, which engage on both sides of the friction ring and provide it with the necessary axial guiding. In turn, the cage can be swivelled about a perpendicular rotation axis; this rotation axis lying in the plane defined by the rotation axes of the conical friction wheels. If the cage is swivelled through a few angular degrees, the friction drive brings about an axial displacement of the adjustment bridge and thus a change of the transmission ratio of the conical friction wheels.

According to the publication in question, a tapered ring transmission of that type is particularly suitable for the front-wheel drive of a motor vehicle that comprises a hydraulic converter on hydraulic clutch, a downstream shifting unit for the tapered friction-ring transmission and a drive output. In this, the drive output component of the hydraulic clutch is mounted on a shaft on which a brake disk is arranged which is electronically controlled. Behind the brake disk is provided a free-running gear wheel which is engaged with a countershaft and can constitute the reverse gear when driven. The gear wheel has crown gear teeth on one side, by means of which it can be brought into engagement with and activated by a shift sleeve with inner axial teeth which is mounted on the shaft and can move axially.

Thus, the conical friction ring transmission consists of two opposed conical friction wheels with equal cone angles arranged on parallel shafts a radial distance apart from one another. The conical friction ring connected to the drive input shaft, the primary cone, is surrounded by the friction ring whose inner and outer surfaces are in frictional engagement, respectively, with the primary cone and with the conical friction wheel connected to the drive output shaft, namely, the secondary cone.

Another conical friction ring transmission and method for adjusting the transmission ratio are described in EP 980 993. This known conical friction ring transmission also comprises two mutually opposed conical friction wheels arranged on parallel shafts and a friction device in active engagement with both of these conical friction wheels but, in this case, a torque acts on the friction device with a component perpendicular to a plane containing the two conical wheel axles. The friction device can be displaced along the conical friction wheels by means of a guide, and is designed such that it presses with a certain torque against the guide. Since the friction device is braced in this way, the risk of transmission flutter is minimized.

In a concrete embodiment, the friction device is arranged between the conical friction wheels and has a first contact zone which rolls against a first of the two conical friction rings and a second contact zone which rolls against a second of the two conical friction rings. Relative to a rotation plane of the friction device, the two contact zones are offset, the plane being perpendicular to a rotation axis of the friction device. Accordingly, the two contact zones are at different distances from the rotation plane.

In this known conical friction ring transmission, the transmission ratio is adjusted as a function of the relative position of the rotating friction element, and the relative position of the friction element can be varied by changing a rotation position relative to an axis. The rotation position of the friction element is used as the controlling parameter for regulation. This rotation position can be varied for example by tilting the frame on the guide rods for the frame. In a concrete embodiment, according to the publication in question, the transmission ratio is regulated by providing rotation speed detectors on both the drive input and the drive output shaft. The control parameter is the rotation speed ratio between the two shafts; this ratio being adjusted by virtue of the rotation position of the friction ring. If the measured rotation speed ratio deviates from the desired value, the position of the friction ring is changed. This causes it to migrate along the outer surface of the conical friction wheels until the desired rotation speed ratio is reached; the rotation position of the friction ring then being modified correspondingly to bring it once more parallel to the conical friction wheel axles.

In relation to costs and efficiency, it would be desirable to have a conical ring transmission in which, at least when driving forward, transmission takes place from the secondary cone to the differential in one step. In this, besides the problem of structural length particularly in relation to the structure of the reverse gear, the main difficulty is to realize in the conical ring transmission a sufficiently large starting ratio, which the tapered ring transmission should convert by approximately a factor of 3 at slow speeds.

If conical ring transmissions with cones of different size are used to achieve this objective, the diameter of the secondary cone must be longer than that of the primary cone. This, however, reduces the spread of the tapered ring transmission and thus also its attractiveness.

The purpose of the present invention is to design a conical ring transmission which provides a large starting transmission ratio at the same time as a large spread.

This objective is achieved by the characterizing features of claim 1. Other design features and advantages emerge from the subordinate claims.

Starting from a conical ring transmission with two mutually opposed cones arranged to rotate on two shafts, namely a primary cone and a secondary cone, and with a ring that engages with both cones and surrounds one of the cones, according to the invention, it is provided that the two shafts for the cones are arranged at an angle to one another.

By virtue of the fact that the shafts for the two cones, the primary cone and the secondary cone, are no longer parallel, but at an angle to one another, the desired large starting transmission ratio can be realized at the same time as a large spread. An additional advantage is that costs are saved by doing without an intermediate transmission shaft, chain wheels, a chain and bearings, while efficiency is also improved by the omission of an intermediate step and the structural space occupied is more compact.

Below, the invention is described in more detail with reference to the drawing, which shows:

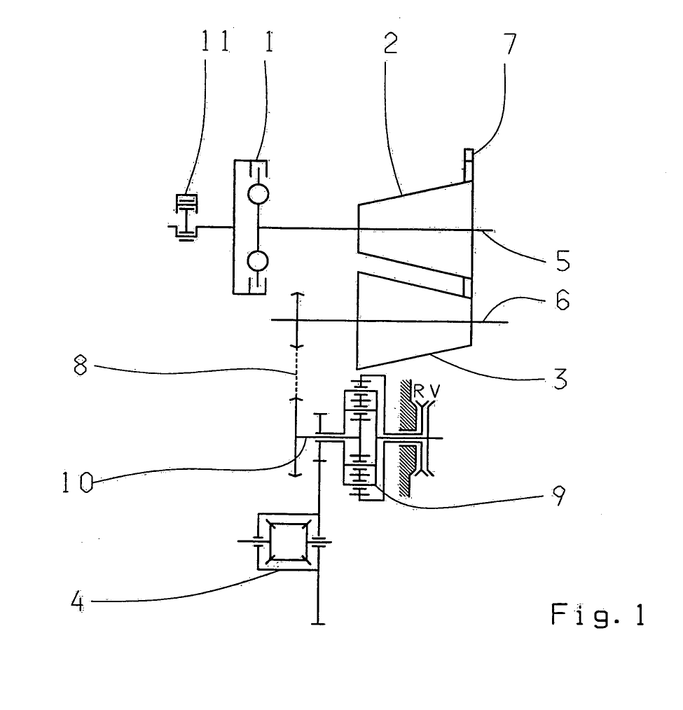

FIG. 1 is a schematic illustration of the arrangement of the primary and secondary cones in a conventional conical ring transmission; and

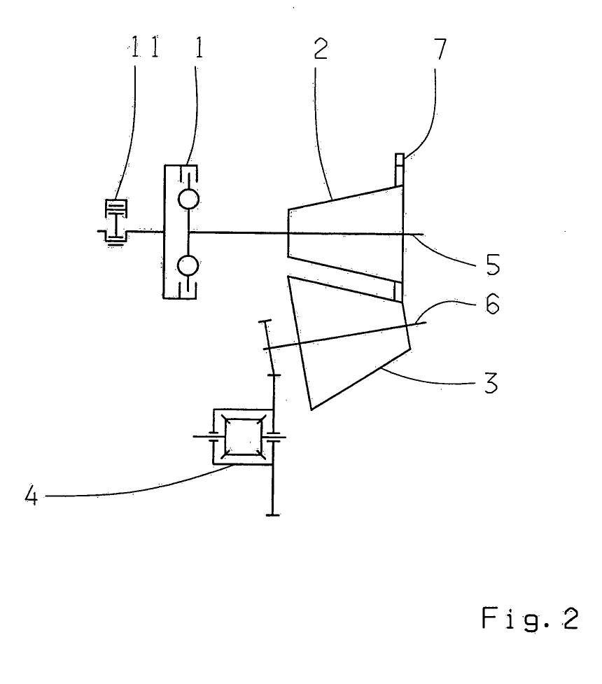

FIG. 2 is a schematic illustration of the arrangement of the primary and secondary cones in a conical ring transmission according to the invention.

In the example embodiment of a conventional conical ring transmission illustrated schematically in FIG. 1, an index 1 denotes a clutch by means of which the conical ring transmission can be connected to an engine 11 of a motor vehicle. In this case the clutch is a dry clutch with integrated torsion damper. A primary cone 2 is in connection with a secondary cone 3 via a ring 7, which surrounds the primary cone. The shafts of the primary and secondary cones are indexed 5 and 6, respectively. These two shafts 5, 6 are arranged parallel to one another.

In this case a chain indexed 8 transmits the torque from the secondary cone 3 to an intermediate shaft 10 on which a planetary gearset 9 is fitted. A differential is indexed 4.

In the example embodiment of a conical ring transmission according to the invention illustrated schematically in FIG. 2, the indexes 1, 2, 3, 7 and 4 are, respectively, again used to denote the clutch, the primary cone, the secondary cone, the ring and the differential. In this case, however, the two shafts 5 for the primary cone and 6 for the secondary cone are arranged at a slight angle, not equal to zero, relative to one another. The said angle is of the order of 1 to 15 degrees and preferably between 2 and 6 degrees.

For simplicity, the reverse gear is not shown in the schematic illustration of FIG. 2.

The configuration according to the invention can be used not only for conical ring transmissions with two mutually opposed cones rotating on two shafts, but also for transmissions which have two rotationally symmetric bodies instead of cones.

Reference Numerals

1 clutch
2 primary cone
3 secondary cone
4 differential
5 shaft
6 shaft
7 ring
8 chain
9 planetary gear set
10 shaft
11 engine

1. Transmission with two mutually opposed rotationally symmetric bodies arranged to rotate on two shafts, in particular a conical ring transmission with a primary cone and a secondary cone and with a ring which is in engagement with both cones and surrounds one of the cones, characterized in that the shafts (5, 6) for the rotationally symmetric bodies or for the primary cone (2) and the secondary cone (3) respectively, are at an angle not equal to zero relative to one another.

2. Conical ring transmission according to claim 1, characterized in that the said angle is between 1 and 16 degrees.

3. Conical ring transmission according to claim 1, characterized in that the said angle is between 2 and 7 degrees.
